(19) United States
(12) Patent Application Publication
(10) Pub. No.: US 2009/0142452 A1
(43) Pub. Date: Jun. 4, 2009

(54) Dissolvable Orally Consumable Flavored Sensual Enhancement Films

(75) Inventor: Michael David Campbell, Beavercreek, OH (US)

Correspondence Address: DINSMORE & SHOHL LLP, ONE DAYTON CENTRE, ONE SOUTH MAIN STREET, SUITE 1300, DAYTON, OH, 45402-2023, US

(73) Assignee: Michael David Campbell, Beavercreek, OH (US)

(21) Appl. No.: 12/273,946

(22) Filed: Nov. 19, 2008

Related U.S. Application Data
(60) Provisional application No. 61/003,629, filed on Nov. 19, 2007.

(51) Int. Cl. A23L 1/22; A23L 1/035; A23L 1/27

(52) U.S. Cl. 426/87; 426/89; 426/250; 426/561; 426/650

(57) ABSTRACT

An orally consumable flavored film that adheres to the skin is provided and includes at least one flavoring agent, at least one film forming agent, a filler, a plasticizer, and a binder or thickener. The film is used in a method for delivering oral, olfactory, or sexual enhancement or stimulation comprising, providing the orally consumable flavored film, wetting the film and adhering the film to the skin, and licking the film such that it disintegrates in the mouth without leaving a substantial residue.

### CROSS REFERENCE TO RELATED DISCLOSURES

This application is filed with reference to a prior Document Disclosure #0 541012, entitled Flavored Edible Gelatin/Paper Body Strips filed Oct. 30, 2003. This application claim priority to prior-filed U.S. Provisional Application Ser. No. 61/003,629, filed Nov. 19, 2007. The entire contents of that provisional application are incorporated by reference herein.

### FIELD OF THE INVENTION

This disclosure pertains to the area of films for human consumption providing flavor satisfaction, including films that utilize orally soluble edible films with appealing flavors and/or sweeteners. Such films provide oral satisfaction, sensual stimulation, and/or enhancement by adhering the films to the skin.

### BACKGROUND

There are a multitude of commercially available films that are orally consumable. Many of these films provide flavor satisfaction and/or craving satisfaction. Many of these films deliver breath deodorizing and antimicrobial agents. Other films contain neutraceuticals and can deliver medicine or vitamins. Many of the films are fast dissolving. There is a need for alternative uses and applications for said films.

### SUMMARY

To address those needs, embodiments of the present invention provide water soluble consumable films that adhere to the skin and dissolve at predetermined rates upon contact with the human tongue.

According to one aspect of the invention, an orally consumable flavored film that adheres to the skin is provided and includes at least one flavoring agent, at least one film forming agent, a filler, a plasticizer, and a binder or thickener. The film may contain such other optional ingredients as sweeteners, surfactants, stabilizing agents, emulsifiers, effervescent agents, encapsulants, and colorants.

In other embodiments, the orally consumable flavored film comprises a plurality of layers, and each layer may contain a different flavoring agent. Alternatively, the orally consumable flavored film may include adjacent areas that contain different flavoring agents, for example, alternating stripes containing different flavoring agents. In some embodiments, the orally consumable flavored film may include an image, text, or graphics embossed or printed on at least one major surface of the film.

In another embodiment of the invention, a method for delivering oral, olfactory, or sexual enhancement or stimulation is provided and includes the steps of, providing an orally consumable flavored film comprising at least one flavoring agent, at least one film forming agent, a filler, a plasticizer, and a binder or thickener, wetting said film; adhering the film to the skin; and licking the film such that it disintegrates in the mouth without leaving a substantial residue. In some embodiments, the film dissolves in from about 30 seconds to about 10 minutes, more preferable from about 30 seconds to about 120 seconds.

Accordingly, it is a feature of embodiments of the present invention to provide water soluble consumable films that adhere to the skin and dissolve at predetermined rates upon contact with the human tongue and provide oral, olfactory, or sexual enhancement or stimulation. These and other features of the invention will become apparent from the following detailed description, the accompanying drawings, and the appended claims.

### BRIEF DESCRIPTION OF THE DRAWINGS

FIG. 1 depicts a circle shaped film positioned on the breast area.

FIG. 2 depicts a rectangle shaped film positioned on the lower abdomen.

### DETAILED DESCRIPTION

Film for human consumption providing sensual stimulation and/or enhancement, oral satisfaction and/or enhancement including films that utilize orally soluble edible films with appealing flavors and/or sweeteners and other ingredients are described in general and by way of specific examples below. The film is orally soluble such that it disintegrates slowly upon contact with a human mouth without leaving substantial residue that can be felt by the human tongue or which needs to be swallowed or ejected from the mouth. The film can include at least one flavoring, the flavoring providing a strong flavor sensation to a person who contacts the film with his or her tongue. A sweetener providing a sweetening sensation can also be used. The film can be one or more layers.

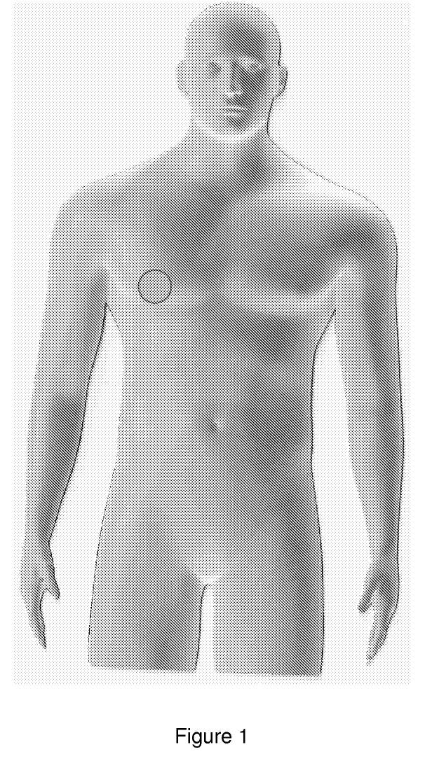

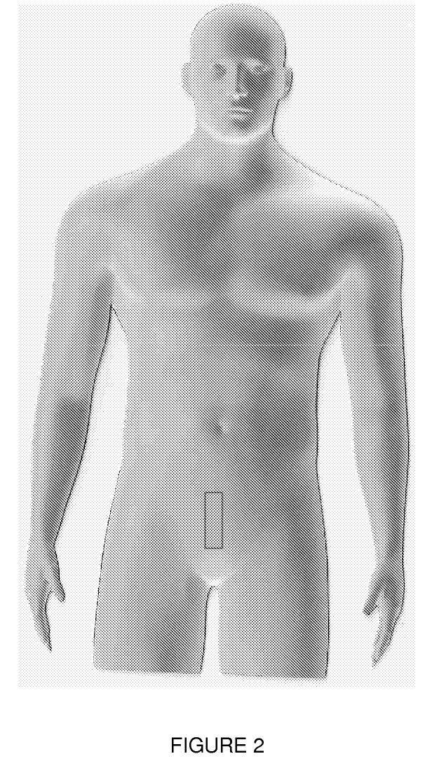

Additional layers or materials can be provided to preserve the structure of the film prior to use and/or to enhance or increase flavor sensations, and/or to provide a sensation of tartness, a sharp or sour flavor sensation. The application of the film is designed to be on the skin. FIGS. 1 and 2 depict typical locations for films made in accordance with embodiments of the present invention.

In order for the film to adhere to the skin it must be wetted by saliva, water, or a liquid. The film can be left to dry or left moist on the skin. The film can be adhered to the skin by an adhesive layer on one side of the film. The film can then be licked off to provide oral and physical sensation in the human mouth. There are many advantages of this type of film, some being: sexual, oral, and olfactory stimulation.

### Film Forming Ingredients

Orally soluble edible films can include many ingredients. The base ingredients for forming a film can include water (which can be later partially or completely dried out of the film) and a film forming agent. Many other additives can be used as well for purposes of saliva stimulation, plasticizing, stabilizing, emulsifying, fillers, thickening, binding, coloring, or acting as a surfactant.

The film can include pullulan as a film-forming agent, and can also include water, additional film-forming agents, plasticizing agents, flavoring agents, sulfur precipitating agents, saliva stimulating agents, cooling agents, surfactants, stabilizing agents, emulsifying agents, thickening agents, binding agents, coloring agents, sweeteners, fragrances, and the like. Further ingredients can be added to accomplish the purposes of the film, which in the prior art are limited to breath freshening, oral hygiene, and dispensing of medicaments and nutraceuticals. Highly-concentrated snack, candy, fruit or food flavors in an orally soluble edible film can be used to meet the needs of flavor satisfaction and/or sensual stimulation.

Film-forming agents can include pullulan, hydroxypropylmethyl cellulose, hydroxyethyl cellulose, hydroxypropyl cellulose, polyvinyl pyrrolidone, carboxymethyl cellulose, polyvinyl alcohol, sodium alginate, polyethylene glycol, xanthan gum, tragacanth gum, guar gum, acacia gum, arabic gum, polyacrylic acid, methylmethacrylate copolymer, carboxyvinyl polymer, amylose, high amylose starch, hydroxypropylated high amylose starch, dextrin, pectin, chitin, chitosan, levan, elsinan, collagen, gelatin, zein, gluten, soy protein isolate, whey protein isolate, casein, polysaccharides, natural gums, polypeptides, polyacrylates, starch, karaya gum, gelatin, mixtures thereof and others.

Film forming agents which can be used within a pullulan-free edible films include, but are not limited to, cellulose ethers; modified starches; natural gums; edible polymers; hydrocolloid flours; seaweed extracts; land plant extracts; derivatives thereof; and combinations thereof.

Examples of cellulose ethers include, but are not limited to, methylcellulose; ethylcellulose; hydroxymethylcellulose; hydroxyethylcellulose; hydroxypropylmethylcellulose; carboxymethylcellulose; derivatives thereof and combinations thereof. Modified starch examples include, but are not limited to, acid and enzyme hydrolyzed corn and potato starches. Further, examples of natural gums include, but are not limited to, gum arabic; guar gum; locust bean gum; carageenan gum; acacia; karaya; ghatti; tragacanth agar; tamarind gum; xanthan gum; derivatives thereof; and combinations thereof.

Examples of edible polymers include, but are not limited to, microcrystalline cellulose; cellulose ethers; xanthan; derivatives thereof; and combinations thereof. Moreover, examples of hydrocolloid flour include, but are not limited to, guar gum; locust bean; microcrystalline cellulose; tara; derivatives thereof and combinations thereof.

Seaweed extract examples include, but are not limited to, alginates; carageenans; derivatives thereof; and combinations thereof. Land plant extract examples include, but are not limited to, konjac; pectin; arabinoglactan; derivatives thereof; and combinations thereof.

It can be useful to avoid substantial amounts of humectant in the film (and more preferable to have no humectant in the film), so as to avoid producing an overly moist, self-adhering film. In particular, it can be useful to formulate the film with a plasticizing agent other than glycerin, which is also a humectant, and with a sweetener other than sorbitol, which is a mild humectant. In cases where over-drying of the film would result in excessive bitterness, a small amount of humectant can help a beneficial small amount of moisture in the film.

An example pullulan free edible film composition can include an effective amount of carageenan as a film forming agent; an effective amount of microcrystalline cellulose as a bulk filler agent; and an effective amount of polyethylene glycol as a plasticizing agent. Additionally, to enhance the structure of the formed film, an effective amount of hydroxyethyl cellulose as a thickening agent can be incorporated.

### Binders

Useful binding agents include starch and other binders known in the field. Other examples include casein and pullulan.

### Thickeners

To further enhance the structure of the film compositions, an effective amount of at least one thickening agent can be used. Suitable thickening agents include, but are not limited to, cellulose ethers, such as hydroxyethyl cellulose, hydroxypropylmethyl cellulose, or hydroxypropyl cellulose, either alone or mixtures thereof. Other useful thickening agents include methylcellulose, carboxyl methylcellulose, and the like. Polymers are also useful thickeners, such as carbomer, polyvinyl pyrrolidone, carboxymethyl cellulose, polyvinyl alcohol, sodium alginate, polyethylene glycol, natural gums like xanthan gum, tragacantha, guar gum, acacia gum, arabic gum, water-dispersible polyacrylates like polyacrylic acid, methylmethacrylate copolymer, carboxyvinyl copolymers.

### Fillers

A bulk filler agent can be added to the film forming agent for many purposes, including to reduce the “slimy” texture of the compositions. The effective amount of the bulk filler can vary. Suitable bulk filler agents include, but are not limited to, magnesium carbonate; calcium carbonate; calcium phosphate; calcium sulfate; magnesium silicate; aluminum silicate; ground lime stone; clay; talc; titanium dioxide; microcrystalline cellulose; cellulose polymers such as wood; derivatives thereof; and combinations thereof.

### Plastcizers

To improve flexibility and reduce brittleness of the edible film compositions, a softener, also known as a plasticizing agent, can be used. The effective amount of the plasticizing agent of the present invention can be as desired. Typically orally soluble edible films are brittle unless plasticized.

Suitable plasticizing agents of the present invention include, but are not limited to, polyols such as sorbitol; glycerin; polyethylene glycol; propylene glycol; monoacetin; diacetin; triacetin; hydrogenated starch hydrolysates; corn syrups; derivatives thereof; and combinations thereof. A polyalcohol can be used to achieve the desired level of softness of the film. Examples of polyalcohols include glycerol (glycerine), polyethylene glycol, propylene glycol, glycerol monoesters with fatty acids or other pharmaceutically used polyalcohols. The concentration of the polyalcohol in the dry film can be as desired. Some of the plasticizers are water soluble and are miscible with a polymer.

L-menthol can impart plasticization and this has been a beneficial side-effect for breath freshening films, but L-menthol can detract from the flavors of for example the fruit-flavored films of my inventions. Likewise, other plasticizing agents typically cited for film forming agents impart a bitter or otherwise very bad taste to the film, or, in the case of humectant plasticizers such as glycerin, attract moisture into the film in humid environments and cause the film pieces to undesirably adhere to adjacent film pieces.

Some suitable plasticizers include, for example and particularly for oral-mucosal contact and other use in the oral cavity, glycerin, sorbitol, any of the glycols, polysorbate 80, triethyl titrate, acetyl triethyl titrate, and tributyl titrate.

### Surfactants

Surfactants can optionally be included in the films. The purpose of including one or more surfactants in the films is to prefent beading of the hydrated film solution on the film-forming substrate, especially when the film contains oils or other non-polar materials. Useful surfactants include mono and diglycerides of fatty acids and polyoxyethylene sorbitol esters, such as, Atmos 300 (trademark) and Polysorbate 80 (trademark). When a combination of surfactants is used, the first component can be a polyoxyethylene sorbitan fatty acid ester or a .alpha.-hydro-.omega.-hydroxypoly (oxyethylene)poly(oxypropylene)poly(oxy-ethylene) block copolymer, while the second component can be a polyoxyethylene alkyl ether or a polyoxyethylene castor oil derivative. Other surfactants include fatty acid esters, pluronic acid, sodium lauryl sulfate, and the like. A surfactant can be added in a desired amount.

### Stabilizing Agents

Useful cooling agents include monomenthyl succinate. Other suitable cooling agents include WS3 (trademark), WS23 (trademark), Ultracool II (trademark) and the like.

### Emulsifiers

If desired, an emulsifier can be included in the film. An emulsifier can be desirable if the film includes oil which normally would not mix with the water component used in making the film. Emulsifiers can improve manufacturability and consistency of the film. Exemplary emulsifying agents include casein, triethanolamine stearate, quaternary ammonium compounds, acacia, gelatin, lecithin, bentonite, veegum, and the like.

### Flavorings

One aspect of the film is the use of more than one flavor in the film. Such a multiplicity of flavor within the mouth enhances the ingestion experience, in a similar way for example as chocolate topping on vanilla ice cream. Not by way of limitation, this can be accomplished two ways: First, by using multiple feed streams of differently flavored films when casting or extruding the films; and second, by having a multiple-layer film with each layer of a different flavor. In the latter case, the film can be co-cast or co-extruded, or can be bonded together with a water soluble edible binder. For example, one layer can be caramel flavored and the other layer can be blackberry flavored. As another example, a single layer film can be striped with alternating layers that are raspberry flavored with a red color and cream flavored with a white color.

While water-based, spray-dried, alcohol/glycol-based, or semi-concentrated flavors can fulfill these aspects of the snacks, it has been discovered that highly-concentrated oil-soluble flavors, whether natural or artificial or combinations thereof, can be satisfactory. Such highly-concentrated oil-soluble flavors provide sufficient flavoring to be considered intense, particularly in combination with the sweetening regimen provided below, even when delivered in the small film size suited for the mouth. The highly-concentrated, oil-soluble snack, candy, fruit or food flavors can provide the required intensity of flavor without the bitterness associated with attempts to obtain that level of flavor with water-based, spray-dried, alcohol/glycol-based, or semi-concentrated flavors. Further, since the oil-soluble flavor is not water soluble, it lingers in the mouth much longer, providing an extended period of flavor satisfaction.

The flavorings that can be used include those known to the skilled artisan, such as natural and artificial flavors. These flavorings can be chosen from synthetic flavor oils and flavoring aromatics, and/or oils, oleo resins and extracts derived from plants, leaves, flowers, fruits and so forth, and combinations thereof. Representative flavor oils include: spearmint oil, cinnamon oil, peppermint oil, clove oil, bay oil, thyme oil, cedar leaf oil, oil of nutmeg, oil of sage, and oil of bitter almonds. Also useful are artificial, natural or synthetic fruit flavors such as vanilla, chocolate, coffee, cocoa and citrus oil, including lemon, orange, grape, lime and grapefruit and fruit essences including apple, pear, peach, strawberry, raspberry, cherry, plum, pineapple, apricot and so forth. These flavorings can be used individually or in admixture. Commonly used flavors include mints such as peppermint, wintergreen, spearmint, birch, anise and such fruit flavors, as cherry, lemon-lime, orange, grape, artificial vanilla, cinnamon derivatives, and others, whether employed individually or in admixture. Flavorings such as aldehydes and esters including cinnamyl acetate, cinnamaldehyde, citral, diethylacetal, dihydrocarvyl acetate, eugenyl formate, p-methylanisole, and so forth can also be used.

Generally, any flavoring or food additive, such as those described in Chemicals Used in Food Processing, publication 1274 by the National Academy of Sciences, pages 63-258, can be used. Further examples of aldehyde flavorings include, but are not limited to acetaldehyde (apple); benzaldehyde (cherry, almond); cinnamic aldehyde (cinnamon); citral, i.e., alpha citral (lemon, lime); neral, i.e. beta citral (lemon, lime); decanal (orange, lemon); ethyl vanillin (vanilla, cream); heliotropine, i.e., piperonal (vanilla, cream); vanillin (vanilla, cream); alpha-amyl cinnamaldehyde (spicy fruity flavors); butyraldehyde (butter, cheese); valeraldehyde (butter, cheese); citronellal (modifies, many types); decanal (citrus fruits); aldehyde C-8 (citrus fruits); aldehyde C-9 (citrus fruits); aldehyde C-12 (citrus fruits); 2-ethyl butyraldehyde (berry fruits); hexenal, i.e. trans-2 (berry fruits); tolyl aldehyde (cherry, almond); veratraldehyde (vanilla); 2,6-dimethyl-5-heptenal, i.e. melonal (melon); 2-6-dimethyloctanal (green fruit); and 2-dodecenal (citrus, mandarin); cherry; grape; mixtures thereof; and the like. Films can also be flavored to compliment alcoholic drinks. For example, lime flavored film that can be used after an alcoholic tequila shot. It can also be flavored favorite desserts, for example, strawberry shortcake and hot fudge sundae. The film can also be flavored with specific brands of alcohol by working with alcohol manufacturers.

The amount of flavoring employed is normally a matter of preference subject to such factors as flavor type, individual flavor, and strength desired. Thus, the amount can be varied in order to obtain the result desired in the final product. Such variations are within the capabilities of those skilled in the art without the need for undue experimentation.

### Sweeteners

Artificial sweeteners are known to impart an aftertaste when used alone to impart sufficient sweetness to a sweetened film, and different sweeteners impart their peak sweetness at different times over the entire time that optimized flavors stay in the mouth. The films can provide a full level of sweetness desired without substantial aftertaste and providing at least some sweetness during the entire flavor experience.

Artificial sweeteners such as aspartame, acesulfame potassium, and sucralose can impart an aftertaste when used alone to impart sufficient sweetness to a sweetened film. In addition to this problem, different sweeteners impart their peak sweetness at different times after hydration with saliva. Use of one sweetener alone thus will not impart the sweetness desired over the entire time that optimized flavors stay in the mouth, being too early or too late.

Suitable sweeteners that can be included are those well known in the art, including both natural and artificial sweeteners. Suitable sweeteners can include, e.g.:

A. water-soluble sweetening agents such as monosaccharides, disaccharides and polysaccharides such as xylose, ribose, glucose (dextrose), mannose, galactose, fructose (levulose), sucrose (sugar), maltose, invert sugar (a mixture of fructose and glucose derived from sucrose), partially hydrolyzed starch, corn syrup solids, dihydrochalcones, monellin, steviosides, and glycyrrhizin;

B. water-soluble artificial sweeteners such as the soluble saccharin salts, i.e., sodium or calcium saccharin salts, cyclamate salts, the sodium, ammonium or calcium salt of 3,4-dihydro-6-methyl-1,2,3-oxathiazine-4-one-2, 2-dioxide, the potassium salt of 3,4-dihydro-6-methyl-1,2,3-oxathiazine-4-one-2,2-dioxide (acesulfame-K), the free acid form of saccharin, and the like;

C. dipeptide based sweeteners, such as L-aspartic acid derived sweeteners, such as L-aspartyl-L-phenylalanine methyl ester (aspartame) and materials described in U.S. Pat. No. 3,492,131, L-alpha-aspartyl-N-(2,2,4,4-tetramethyl-3-thietanyl)-D-alaninamide hydrate, methyl esters of L-aspartyl-L-phenylglycerin and L-aspartyl-L-2,5,dihydrophenyl-glycine, L-aspartyl-2,5-dihydro-L-phenylal-anine, L-aspartyl-L-(1-cyclohexyen)-alanine, and the like;

D. water-soluble sweeteners derived from naturally occurring water-soluble sweeteners, such as a chlorinated derivative of ordinary sugar (sucrose), known, for example, under the product description of sucralose; and

E. protein based sweeteners such as thaumatoccous danielli (Thaumatin I and II).

Other sweeteners can be used as well.

### Sour Films

One difficulty in making good tasting flavor films is in providing highly sour flavors, for example sour apple or sour lemon or sour peach. Sourness, or tartness, is generally caused by low pH. Low pH is known to adversely affect nearly all of the film forming ingredients, causing for example brittleness, low tensile strength, and short shelf life. Common edible acids are citric, tartaric and maleic acid.

### Effervescence

An optional aspect of the films is the inclusion of the property of effervescence. Advantages of effervescence include without limitation the delight of people and the more effective coating of the oral cavity with the flavors. The effervescence can be in the form of loud snappy bubbles or quiet foamy bubbles or any combination thereof. Loud snappy bubbles are obtained by the inclusion of small bits of a gas-releasing agent in the film.

The gasified candy, when contacted with the mouth, produces an entertaining but short-lived popping sensation. As the candy is wetted in the mouth the candy melts and the gas escapes. The tingling effect in the mouth is sensational but short.

The gasified candy component of the snack can be a hard sugar product having bubbles of gas entrapped therein and is conveniently produced as described below or otherwise. The gasified candy can be prepared from any of the commercially-available sugars employed in the confectionary industry. Thus, such sugars as glucose, fructose, sucrose, lactose and the like, alone or in combination, can be employed. A mixture of sucrose with corn syrup (containing glucose, maltose, dextrin) can also be satisfactory.

The gases used to prepare the gasified candy can be any of the commonly-available gases which are substantially unreactive with the sugar or sugars being employed and include such gases as carbon dioxide, nitrogen or air, but carbon dioxide is useful.

### Encapsulation

The film can also provide for encapsulation of other non-film materials. Encapsulating non-film edible materials such as flavored oils, medicaments, breath fresheners, antiseptic, antimicrobial, nutraceuticals, candy, and the like can be achieved through layering or through a containment chamber within the film.

An aspect of the film is the use of orally soluble edible films for encapsulation of other materials which are desirably output into the oral cavity when the encapsulating film dissolves. This is different than the prior art method of encapsulating medicament pills or neutraceutical pills with edible soluble coatings, since in those cases the intent of the coating is to prevent the medicament or neutraceutical from being released in the oral cavity, but allow its release in the stomach or intestine. In the case of the films, it is the intention to allow the saliva to dissolve away the film encapsulant and release the contents into the oral cavity.

Not by way of limitation, the contents could be flavored, sweetened vegetable oil for flavor satisfaction or craving satisfaction or special flavor effects such spicy hot or sour, or medicaments intended for the oral cavity, or breath fresheners, or candy of any type, or fats or creams. For example, the film encapsulant can be an orally soluble edible film as described above with an apple pie and cinnamon flavor, and the contents can be a cream type candy. When placed in the oral cavity, the consumer first tastes the apple pie, and then when the film dissolves to release the contents, tastes the cream. In this way the consumer gets a sensation similar to apple pie ala mode. As another example, the orally dissolvable edible film encapsulant can have a pleasant sweetened spearmint taste, and the contents can contain essential oils such as menthol or peppermint.

In this way the user experiences a pleasant candy-like mint flavor and ends with a fresh-feeling mouth and the sensation of fresh breath. Encapsulation can take many forms, and the following examples are not by way of limitation. The film can be formed into an envelope, the contents placed within, and the envelope flap closed by tucking or sealing, such as heat sealing or use of a binder for sealing. Or, the film can be formed into a pouch, the material placed into an open end, and the pouch sealed closed. Or, the film can be directly coated onto the contents using pill coating techniques. Or, the film can be made into a two piece capsule such as those used to contain neutraceuticals or medications, such as a specially formulated gelatin capsule, the contents inserted, and the two pieces put together. Or, the film can be made whole around a liquid center by using the known techniques and equipment used to make for example vitamin E capsules.

### Flavor Release Rate

Some of the films described herein will have a flavor release rate that imparts flavor to the human tongue in less than 1 minute. The flavor can last up to 2 or 3 minutes or more. Other flavor release rates are possible.

### Film Shape

If desired, the perimeter of the film can be shaped other than traditional square or rectangular shapes. For example, shaping the film in the form of animals or stars. Or, for example, shaping the film into a company logo or movie character for promotional or advertising purposes. Or, for example, to differentiate one type of film from another, just as prescription medications and vitamin tablets come in unique shapes to differentiate one from another. Not by way of limitation, in flat films, this can be accomplished by standard die cutting techniques. In many cases, the left-over film from the die cutting process can be rehydrated and used again to make new film, thus making the process cost efficient. The film can also be shaped in tape form. Donut shaped film and fruit shaped based on flavor.

### Artwork/Images

In order to increase the attractiveness of the films to the consumer, they can include an exterior surface with an embossed, sculpted, sprayed or printed image, figure, logo, text, graphics, characters, art or words. Edible ink can be used for such optical images. Such optical representations can be related or unrelated to the flavor that the snack provides. Such optical representations can be chosen to cause the consumer to experience pleasant thought when consuming the film, to attract the consumer's attention in a retail location, for advertising, other related or unrelated products, or for other reasons. In general the optical images are provided to make the product more entertaining and delightful than it would be without the optical images.

The films described herein can provide an aesthetic and pleasing appearance through the use of bright and/or multiple colors. The films can be brightly colored and entertaining. Multiple colors can be used including those that intentionally color the human tongue. Glow in the dark materials can be included in order to make the tongue glow in darker locations, such as at dances, in bars, etc. Printing is desirable for other reasons as well. The promotional and advertising industries will benefit by placing logos and other promotional and advertising on the film. Sweepstakes and contest winners could find their prize on the film. Printing, particularly in multiple colors, can also provide visual stimulation, delight, and/or entertainment. It can be important to put trademarks on the film. It can be desirable to print the name of the product on the film to aid in increasing brand awareness. The film can be printed on one side or both sides.

Printing of text, graphics, photographs or combinations thereof onto orally soluble edible films, including but not limited to the snack, candy, fruit or food flavored films can be accomplished through standard printing techniques in combination with the use of edible inks. Alternatively, it can be accomplished with different colored films melded together. Not by way of limitation, two types of inks can be employed. The first type is an ink made from a solution containing the same film forming ingredient as in the orally soluble edible film being printed upon, to which dye or pigment is added. The second types are commonly available vegetable dies. The printing can be done in one or more colors, and it can done while the film is in roll form (prior to being cut for individual packaging) or as it comes off the film line and is heading toward the roller.

The ink can be flavorless, or can add more of the same type of flavor as is in the film, or can add one or more additional flavors, or can add salivary stimulants which will help produce saliva to dissolve the film, or can add tartness or sourness. This last is important since tartness is created by the addition of acid, which if put into the film itself, can harm the desired physical properties of the film. This is true of most film bases. Printed on the exterior of the film, the acid will provide the initial sour flavor burst desired by many consumers, but will not adversely affect the film.

### Coloring

The snacks can use bright or multiple colors, as compared with the muted colors of the prior art. While these can be printed onto the film as previously described, the pigment or dye can be included within the film itself in sufficient intensity to be bright and pleasing to the eye. Further, multiple colors, whether bright or muted, can be used within the same film. Not by way of limitation, this can be accomplished two ways: First, by using multiple feed streams of different colors when casting or extruding the films; and second, by have a multiple-layer film with each layer of a different color. In the latter case, the film can be co-cast or co-extruded, or can be bonded together with a water soluble edible binder.

The coloring agents are used in amounts effective to produce the desired color. Colorants generally include natural food colors and dyes suitable for food, drug and cosmetic applications. These colorants are known as FD&C dyes and lakes. The materials acceptable for the foregoing spectrum of use could be water-soluble, and include FD&C Blue No. 2, which is the disodium salt of 5,5-indigotindisulfonic acid. Similarly, the dye known as Green No. 3 comprises a triphenylmethane dye and is the monosodium salt of 4-[4-N-ethyl-p-sulfobenzylamino)diphenyl-methylene]-[1-N-ethyl-N-p-sulfonium benzyl)-2,5-cyclo-hexadienim-ine]. A full recitation of all FD&C and D&C dyes is available in industry literature.

### Film Packaging

Various containers are provided that provide easy dispensation of the snacks and can provide advertising, labeling, logos, cartoon characters or other information or serve other functions

Breath freshening and oral care films have been marketed in flat containers with a flip top that snaps shut. This is a non-bulky solution to putting a short stack of film pieces in a pocket or purse. However, this type of container does not meet the needs or wants of users in many situations. One problem is that the films are stacked, and sometimes become lightly adhered to one another, especially in humid environments. Even when not adhered, it can be difficult to slide the film out of the container while leaving the other films behind, because to be successful the method requires proper technique, dexterity, and involves the use of the finger which will vary in its friction characteristics from person to person and day to day, and will be seen as non-hygienic by some.

New dispensers for orally soluble edible films can be provided which have one or more of the following functions as compared with prior flat flip-top containers: greater ease or reliability of dispensing, an aesthetically pleasing experience, a more entertaining experience, a more hygienic experience, or the ability to promote, advertise, educate, warn and/or instruct. Greater ease or reliability of dispensing can be provided in a number of ways. First, the dispenser can be designed to operate in a similar way as the prior dispensers which offer the films in discrete pieces in a stack, but have a mechanism with a mechanical ‘finger’, such as with a rubber-clad tip, which drags across the top film in the stack an removes it from the container. In this way, the friction is increased as compared to a finger, the technique is designed into the mechanism and does not require human skill and can be optimized for repeatability, and since the finger does not enter the container (but rather picks off the piece of film after most of it is out of the container), the process is more hygienic.

This mechanism can automatically activate as the lid is opened, so that each time the lid is opened a piece of film is offered. The mechanism can be other than a mechanical finger. It can be thus desired to use a mechanism to easily, repeatably and hygienically offer a piece of film from a stack of films to the consumer. Or the film can be packaged in roll form instead of in discrete pieces. The film can then be dispensed much as a roll of tape in a standard tape dispenser. The film can either be perforated for separation at specific intervals, or a cutting/breaking mechanism can be included in the container, or the film can be made intentionally brittle enough to be broken off, or the tape can be bitten off or dissolved off with the mouth. The film roll can be advanced manually or by a similar mechanical device as described above where a grippy mechanical finger drags the film to unroll it, or other mechanical means to accomplish the same.

The mechanical device can activate by the force and action of opening the lid of such a container. A variation of a roll would be flat pieces that are longer than an individual dose and must be cut, broken, or dissolved off from the rest of the long piece. Such roll containers or long-flat containers provide additional space in comparison with the small flat flip-top prior art containers for promotion, advertising, education, warnings, larger-print ingredient labels, instructions, and items of delight such as movie characters. A further aspect of the containers is the shape of the container itself. The shape can entertain, delight, educate, warn, instruct, promote or advertise. For example, the container can be made into the form of a character or a company symbol. A further aspect is a container which is utilitarian in addition to its containing and dispensing of the film. For example, the container can be part of a key chain, or be designed to fit within a compartment thereof.

### Dissolving or Disintegrating Film

Many of the films disclosed herein will solvate in the saliva found in the human mouth and dissolve or disintegrate completely within 120 seconds, or within some other time interval. A film will be considered to have dissolved or disintegrated completely at such time as it has converted substantially to a syrup or liquid or has broken into particles of such size and mass as to be difficult for the human tongue to detect by size and shape, although the flavor and other sensations of the film linger. The preferable time intervals are between 30 seconds and 60 seconds, between 60 seconds and 120 seconds; between 180 seconds and five minutes; between five minutes and eight minutes; or between eight minutes and ten minutes.

What is claimed is:

1. An orally consumable flavored film that adheres to the skin comprising at least one flavoring agent, at least one film forming agent, a filler, a plasticizer, and a binder or thickener.

2. The orally consumable flavored film as claimed in claim 1 further comprising a sweetener.

3. The orally consumable flavored film as claimed in claim 1 further comprising a surfactant.

4. The orally consumable flavored film as claimed in claim 1 further comprising a stabilizing agent.

5. The orally consumable flavored film as claimed in claim 1 further comprising an emulsifier.

6. The orally consumable flavored film as claimed in claim 1 further comprising an effervescent agent.

7. The orally consumable flavored film as claimed in claim 1 further comprising an encapsulant.

8. The orally consumable flavored film as claimed in claim 1 further comprising a colorant.

9. The orally consumable flavored film as claimed in claim 1 in which said film comprises a plurality of layers.

10. The orally consumable flavored film as claimed in claim 9 in which each layer comprising a different flavoring agent.

11. The orally consumable flavored film as claimed in claim 1 including adjacent areas on said film that contain different flavoring agents.

12. The orally consumable flavored film as claimed in claim 11 in which said adjacent areas comprise alternating stripes containing different flavoring agents.

13. The orally consumable flavored film as claimed in claim 1 including an image, text, or graphics embossed or printed on at least one major surface of said film.

14. A method for delivering oral, olfactory, or sexual enhancement or stimulation comprising, providing an orally consumable flavored film comprising at least one flavoring agent, at least one film forming agent, a filler, a plasticizer, and a binder or thickener, wetting said film and adhering said film to the skin, and licking said film such that it disintegrates in the mouth without leaving a substantial residue.

15. A method as claimed in claim 14 in which said film dissolves in from about 30 seconds to about 10 minutes.

16. A method as claimed in claim 14 in which said film further comprises a sweetener.

17. A method as claimed in claim 14 in which said film further comprises a surfactant.

18. A method as claimed in claim 14 in which said film further comprises a stabilizing agent.

19. A method as claimed in claim 14 in which said film further comprises an emulsifier.

20. A method as claimed in claim 14 in which said film further comprises an effervescent agent.

21. A method as claimed in claim 14 in which said film further comprises an encapsulant.

22. A method as claimed in claim 14 in which said film further comprises a colorant.

23. A method as claimed in claim 14 in which said film comprises a plurality of layers.

24. A method as claimed in claim 23 in which each layer in said film comprises a different flavoring agent.

25. A method as claimed in claim 14 in which said film includes adjacent areas that contain different flavoring agents.

26. A method as claimed in claim 25 in which said adjacent areas comprise alternating stripes containing different flavoring agents.
